(19) United States
(12) Patent Application Publication
(10) Pub. No.: US 2010/0071983 A1
(43) Pub. Date: Mar. 25, 2010

(54) THREE WHEEL VEHICLE REAR SUSPENSION

(76) Inventor: Ronald A. Holland, Orange, CA (US)

Correspondence Address: AVERILL & VARN, 8244 PAINTER AVE., WHITTIER, CA, 90602, US

(21) Appl. No.: 12/237,379

(22) Filed: Sep. 24, 2008

(51) Int. Cl. B62D 61/06; B60K 1/00

(52) U.S. Cl. 180/215; 180/65.1; 903/902

(57) ABSTRACT

A three wheel vehicle rear drive suspension design reduces unsprung weight to improve safety and efficiency. A motor mount is connected between a swivel and a live rear axle housing. The swivel is positioned to allow free motion of the live rear axle, for example, between front frame mounting points of leaf springs. A first motor is attached to the motor mount near the swivel and as a result is mostly sprung weight. The first motor may be a low speed motor for starting out, and the vehicle may include a second high speed motor mounted vertical opposite the first motor also close to the swivel.

The present application claims the priority of U.S. Provisional Patent Application Ser. No. 60/275,021 filed Sep. 25, 2007, which application is incorporated in its entirety herein by reference.

### BACKGROUND OF THE INVENTION

The present invention relates to electric powered three wheel vehicles and more particularly to an improved electric drive train suspension system for three wheel vehicles with drive wheels in the rear.

Known three wheel vehicles with drive wheels in the rear have live rear drive axles with an exposed differential between the two drive wheels. A gear head motor is mounted on top of the differential in an adjustable manor so that the distance between the motor and the differential can be adjusted to accommodate the drive chain from a sprocket on the motor output shaft to a differential sprocket on the differential. The live rear axle is mounted to the vehicle frame through a pair of leaf springs which are rigidly mounted near their centers to the ends of the axle near the wheels. The most common way of mounting leaf springs to the vehicle frame is to pivotally mount a first end of each leaf spring to the vehicle frame and a second opposite end of each leaf spring to a shackle (a vertical link, hinged at both ends). The shackles are pivotally mounted to the vehicle frame at about a right angle to the leaf spring when a normal operating weight is carried by the vehicle, thereby allowing forward and rearward movement of the second leaf spring end during suspension motion. Another common way to mount the leaf springs to the frame is in rolling or sliding contact, in the horizontal direction both forward and backward at each end. This requires the addition of horizontal locating rods swivel mounted on both ends from the frame to the axle on both sides of the vehicle to maintain the rear axle in the correct position.

Regardless of the manner in which the leaf springs are mounted, the leaf springs allow the axles to travel up and down in an essentially vertical direction when the vehicle rolls over bumps. Electric motors used in many three wheel vehicles are often quite heavy. When a heavy electric motor and its mounting apparatus are fixed to the differential, the heavy motor becomes part of the rear axle un-sprung weight. When one of the rear wheels hits a large bump at high speed, approximately half of the mass of the un-sprung weight is rapidly accelerated to a high speed in an upward direction around a roll axis running through the single front wheel to the other rear wheel at ground level. The resulting momentum about the roll axis may easily roll the three wheel vehicle over because there is not an outboard front wheel to resist vehicle roll. This is especially dangerous if the vehicle is turning and the inside wheel hits the bump. It is therefore clear that increasing the un-sprung weight of a live rear axle of a three wheel vehicle increases the probability of roll-over.

Relying on present battery technology, known electric vehicles often may only travel a short distance on a single charge of their batteries. When one or both rear wheels encounter a bump, the wheel(s) attempts to climb over the bump. The energy transferred to the wheel in the form of compression of a tire and lifting the wheel over the bump is never fully recovered and more often very little is actually recovered. The greater un-sprung weight of the rear axle and motor results in greater weight to lift and harder impact of the wheel with the bump. As a result, large un-sprung rear axle weight further decreases vehicle range on rough or bumpy surfaces.

Additionally, greater un-sprung to sprung weight ratio of a vehicle results in a rough ride. Such rough ride is both uncomfortable for a driver and may damage cargo or the vehicle itself.

In summary, the unsprung rear axle weight of known three wheeled vehicle designs compromises safety, reduces efficiency, may damage cargo, and reduce driver comfort.

### BRIEF SUMMARY OF THE INVENTION

The present invention addresses the above and other needs by providing a three wheel vehicle, rear drive system suspension design which reduces unsprung weight to improve safety and efficiency. A motor mount is connected between a swivel and a live rear axle housing. The swivel is positioned to allow free motion of the live rear axle housing, for example, between front frame mounting points of leaf springs. At least one motor is attached to the motor mount near the swivel and as a result is mostly sprung weight. The motor may be geared for low speed for starting out, and the vehicle may include at least one motor geared for higher speed and also mounted close to the swivel.

In accordance with one aspect of the invention, there is provided an electric drive system using a known live rear axle and leaf spring suspension arrangement but including a new motor mounting concept reducing un-sprung weight. In one embodiment, the motor is positioned in front of, and at about the same level as, the differential. A swivel mount is positioned to approximately align with a forward end of the leaf springs and is approximately centered between the forward ends of the leaf springs. A motor mount extends between the swivel mount and the live rear axle and may be pivotally mounted to the axle housing. The motor is mounted to the motor mount close to the swivel mount and the drive chain extends from the sprocket on the motor to the sprocket on the live rear axle. The swivel mount preferably comprises a vertical link swivel mounted to the frame above the motor at an upper end of the vertical link and swivel mounted to the front of the motor mount at a lower end of the vertical link. The vertical link restricts vertical motion between the front end of the motor mount structure and the frame but does not prevent motion in any other direction. This configuration allows the rear axle housing to rotate about the swivel joint at the bottom of the vertical link in both vertical planes when negotiating bumps.

In accordance with another aspect of the invention, there is provided a motor position close to the swivel point such that most of the motor and part of the chain and mounting structure become sprung weight instead of unsprung weight. The amount of each of their masses which remains unsprung weight is reduced to approximately the distance from the pivot point to their center of mass divided by about the distance from the pivot point to the rear axle housing. This reduction in unsprung weight reduces the roll momentum created when one of the rear wheels hits a large bump at high speed or in a tight turn, thereby reducing the tendency for the three wheel vehicle to roll over.

Another embodiment of the present invention employs a two motor drive system but in the same swivel mount and motor mount as described above. This configuration is particularly advantageous when employing the two motor drive because the additional weight is mostly sprung weight. A two motor drive that utilizes one motor to drive the vehicle up to about half of its top speed and the other motor to drive the vehicle on up to top speed, greatly improves efficiency and consequently range. Adding a second motor to known rear suspension systems (i.e., both motors as unsprung weight) would be prohibitive regarding safety (roll over), ride, and efficiency.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a top view of a prior art three wheel vehicle with suspension including a motor mounted on top of the live rear axle housing.

FIG. 2 is a partial side view of the prior art three wheel vehicle.

FIG. 3 is a top view of a three wheel vehicle rear suspension according to the present invention.

FIG. 4A is a partial side view of the three wheel vehicle rear suspension including a motor mount pivotally mounted at a forward end and fixed to the live rear axle housing at a rearward end.

FIG. 4B is a partial side view of the three wheel vehicle rear suspension including a motor mount pivotally mounted at a forward end and pivotally mounted to the live rear axle housing at a rearward end.

FIG. 5 is a top view of a three wheel vehicle including a single motor mounted to the motor mount according to the present invention.

FIG. 6 is a partial side view of the three wheel vehicle including the single motor mounted to motor mount according to the present invention.

FIG. 7 is a top view of a three wheel vehicle including a two motors mounted to the motor mount according to the present invention.

FIG. 8 is a partial side view of the three wheel vehicle including the two motors mounted to the motor mount according to the present invention.

FIG. 9 is a partial side view of a three wheel vehicle including two gearless motors and a jackshaft for speed reduction mounted to the motor mount according to the present invention.

FIG. 10 is a partial top view of the three wheel vehicle including two gearless motors and a jackshaft for speed reduction mounted to the motor mount according to the present invention.

FIG. 11A shows details of the two gearless motors and the jackshaft with the motors mounted above the jackshaft.

FIG. 11B shows details of the two gearless motors and the jackshaft with the motors mounted below the jackshaft.

FIG. 12 is a top view of a three wheel vehicle including four motors mounted to a second motor mount according to the present invention

FIG. 13 is a partial side view of the three wheel vehicle with the four motors mounted to the second motor mount according to the present invention.

FIG. 14 is a rear view showing the arrangement of the four motors.

FIG. 15 shows a top view of the second motor mount according to the present invention for the four gear-motor drive system.

FIG. 16 is a top view of a second three wheel vehicle including four motors mounted to a second motor mount according to the present invention

FIG. 17 is a partial side view of the second three wheel vehicle with the four motors mounted to the second motor mount according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

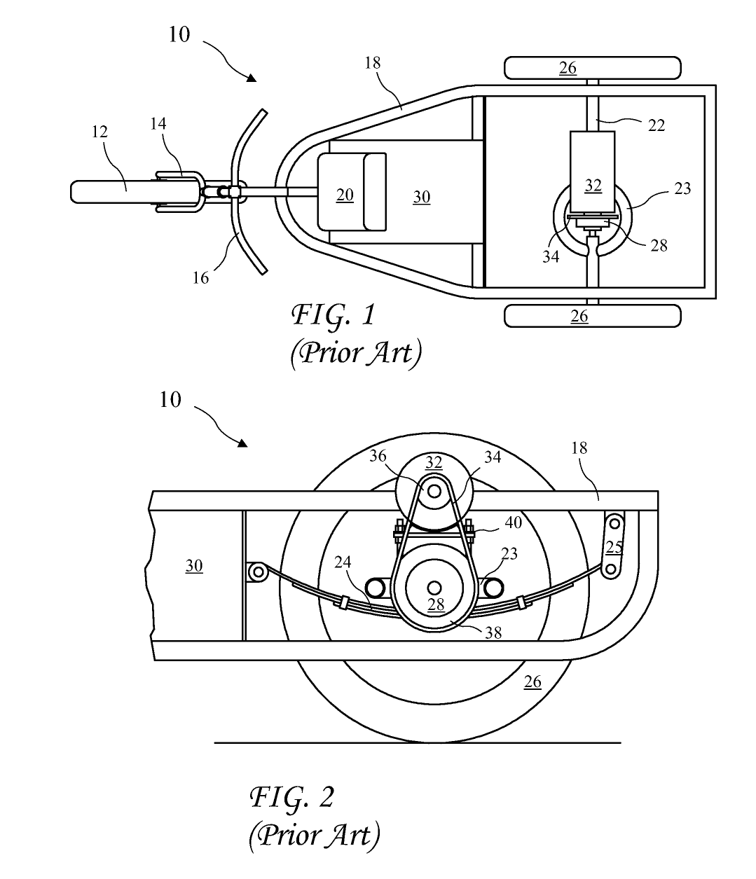

FIGS. 1 and 2 illustrate a prior art three wheel electric drive vehicle 10 with a front wheel 12 rotatably mounted in fork 14 which in turn is rotatably mounted onto the front of frame 18 with handle bars 16 mounted to the top of fork 14 for steering the vehicle from seat 20. Two rear wheels 26 are rotatably mounted on right and left axle rotatably residing in a live axle housing 22 and differential loop 23 which are springedly mounted to the frame 18 through two leaf springs 42 with shackles 25 connecting the rear of each leaf spring 24 to the frame 18. The leaf springs 24 are mounted just inboard of each rear wheel 26.

A side view of the position of one of the leaf springs 24 and shackles 25 on the right side of the vehicle 10 is shown in FIG. 2; although not shown, the position of the left leaf spring 24 and shackle 25 is the same on the left side of the vehicle 10. A battery pack 30 is typically mounted low and toward the center of the vehicle 10 to maintain a low center of gravity (c.g.) and a small polar moment of inertia. An electric motor 32 is mounted above the axle housing 22 by adjustable mounting structure 40 and drives a differential 28 through a motor sprocket 36, chain 34, and differential sprocket 38 mounted to the differential 28. The differential 28 allows the two rear wheels 26 to rotate independently at rotational rates proportional to an instantaneous turning radius of the vehicle 50 to prevent the tires 26 from skidding when the vehicle 10 goes around turns.

The motor 32 must be mounted high enough above differential sprocket 38 to allow chain 34 to wrap around a small motor sprocket 36 sufficiently to transmit the required power to the differential sprocket 38. It can be seen from this example that solidly mounting the motor 32 to the live rear axle housing 22 adds greatly to the unsprung weight of the vehicle 10 and that mounting the heavy motor 32 high above the live rear axle housing 22 raises the center of gravity of the typical prior art three wheel, electric drive vehicle.

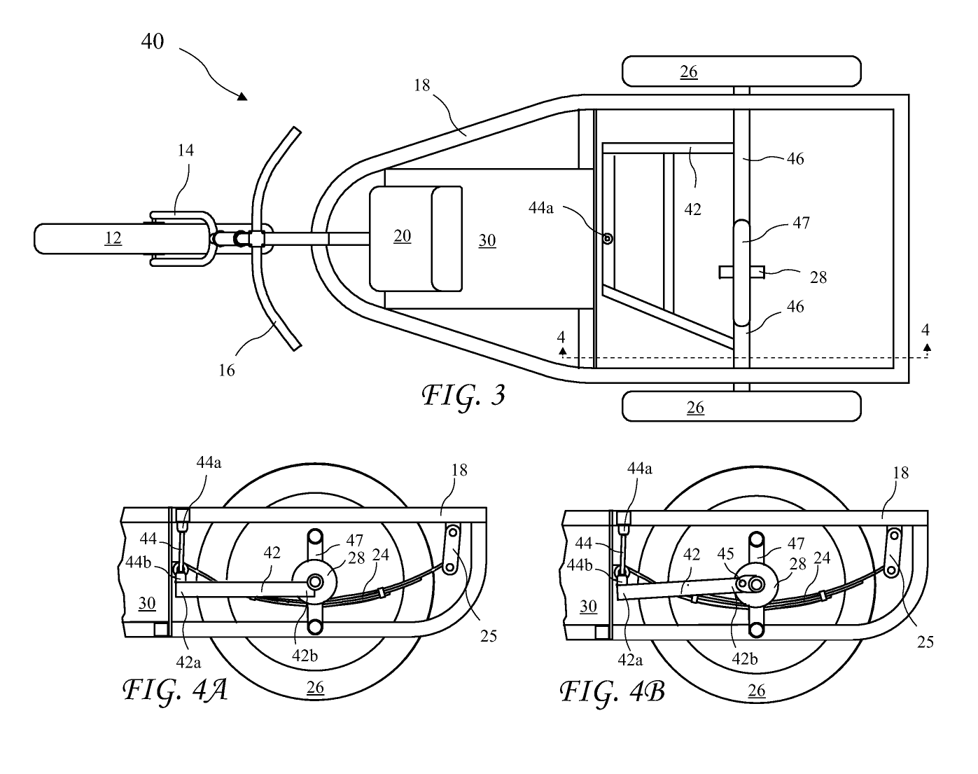

A top view of a three wheel vehicle 40 with a motor mount 42 according to the present invention is shown in FIG. 3, a partial side view of the three wheel vehicle including the motor mount 42 pivotally mounted at a forward end 42a and fixed to the live rear axle housing 46 at a rearward end 42b is shown in FIG. 4A, and a partial side view of the three wheel vehicle including the motor mount 42 pivotally mounted at the forward end 42a and pivotally mounted to the live rear axle housing 46 at a rearward end is shown in FIG. 4B. The forward end 42a of the motor mount 42 is pivotally connected to a link 44 by a lower swivel joint 44b. The link 44 is connected to the frame by an upper swivel joint 44a. Such mounting of the motor mount 42 provides sufficient restraint of the motor mount 42 for operation but decouples the forward end 42a of the motor mount 42 from vertical motion of the live rear axle housing 46. Thus making the forward end 42a of the motor mount 42 spring, and any weight attached to the motor mount 42 near the forward end 42a, mostly sprung. More significantly, a heavy motor mounted near the forward end 42a of the motor mount 42 will not be accelerated vertically when the live rear axle housing 46 encounters a bump, and will not result in angular momentum likely to cause the three wheel vehicle to overturn. Such motor mount may also be used with internal combustion engines or any engine to obtain the same advantage.

The motor mount of the present invention is not limited to leaf spring axles, and any three wheel vehicle with a motor mount with one end attached to the live rear axle housing and an opposite end connected to joint to fix the vertical position of the motor mount end, is intended to come within the scope of the present invention.

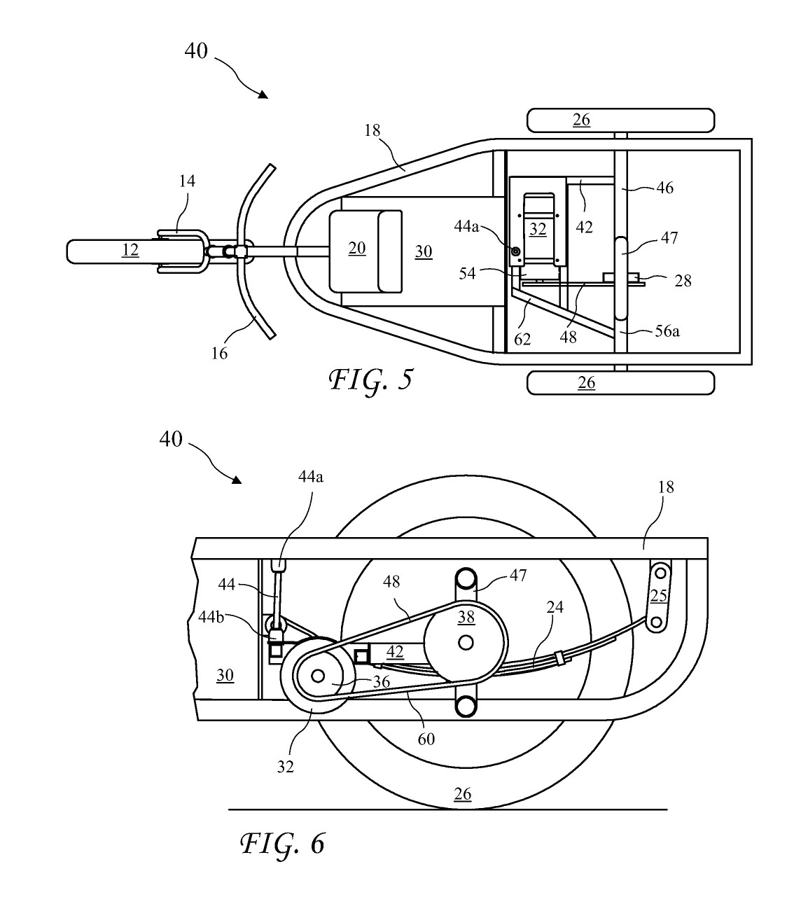

FIGS. 5 and 6 show a three wheel vehicle 40 according to the present invention with a single gear-motor drive system mounted in front of a live rear axle housing 46. Gear-motor 32 is adjustably mounted to motor mount 42 which is fixedly mounted to axle housing 46 on each side of differential 28. The gear-motor 32 includes gears for reducing the motor shaft speed. The lower swivel joint 44b on the approximately vertical link 44 is mounted to the front end 42a (see FIG. 4A) of motor mount 42 about centered between sides of vehicle 40. The upper swivel joint 44a on link 44 is mounted to the frame 18 approximately above the lower swivel joint 44b so that when the vehicle 40 rolls over a bump the live rear axle housing 46 is free to move vertically in frame 18 with the motor/axle assembly rotating around the lower swivel joint 44a to decouple the forward end 42a of the motor mount 42 from vertical motion of the live rear axle housing 46. The motor 32 is mounted as close as possible to the center of rotation of swivel joint 44a to also decouple the motor 32 from vertical movement of axle housing 46. Therefore, most of the weight of motor 32, and some of the weight of the motor mount 42, is sprung weight and the low, forward position of the heavy motor 32 decreases the polar moment of inertia of the unsprung rear suspension elements around the roll axis, and lowers the center of gravity of vehicle 40 when compared to the typical prior art three wheel vehicle 10.

A motor sprocket 36 attached to the motor shaft of the motor 32 drives a differential sprocket 38 through a chain 48 which couples the sprockets 36 and 38. Sprocket 38 is fixedly mounted to differential 28 which drives the two rear wheels 26 in proportion to the turning radius of the vehicle. The motor 32 is preferably mounted low in the motor mount 42 to place most of the weight of the motor 32 low to lower the overall center of gravity of the vehicle 40.

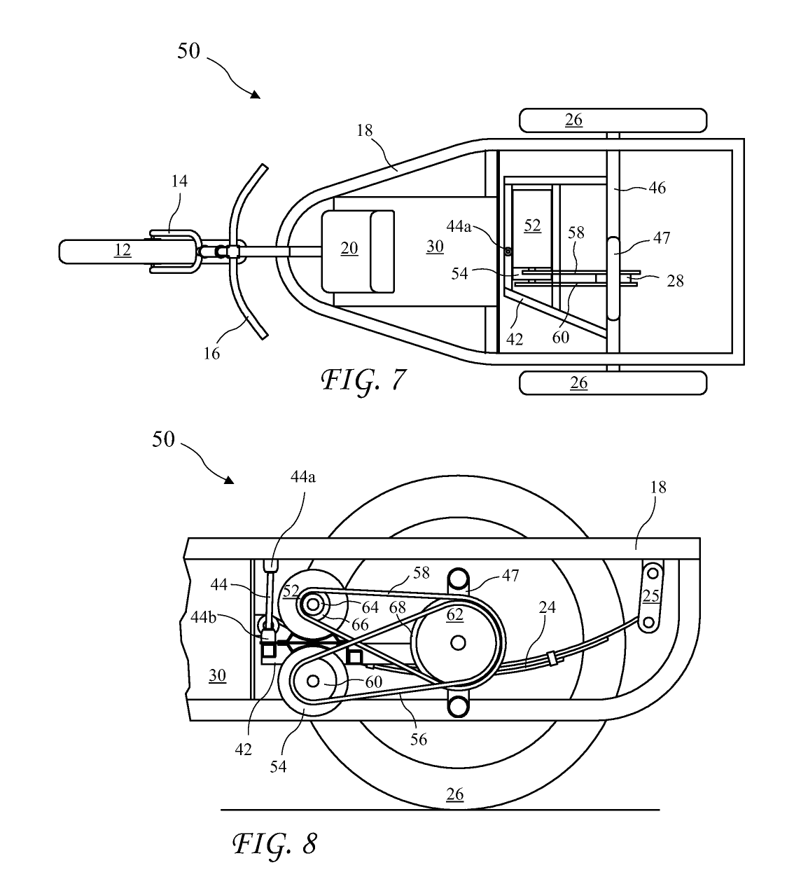

FIGS. 7 and 8 show a three wheel vehicle 50 according to the present invention with a dual low vehicle speed gear-motor 52 and high vehicle speed gear-motor 54 mounted to the motor mount 42 in front of the live rear axle housing 46. Vehicle 50 is the same as vehicle 40 of FIGS. 5 and 6 except that two slightly smaller gear-motors 52 and 54 replace the single gear-motor 32. The low vehicle speed gear-motor 52 is adjustably mounted above the high vehicle speed gear-motor 54 on the motor mount 42. A clutch bearing 64 is attached to the motor shaft of the low vehicle speed motor 52 and the first motor sprocket 66 is attached to the outer case of the clutch bearing 64. A first chain 58 couples the motor sprocket 66 with a first differential sprocket 68 attached to the differential 28. The motor sprocket 66 and differential sprocket 68 provide a low ratio and the motor 52 drives the vehicle 50 up to about half speed.

A second motor sprocket 60 is attached to the motor shaft of the gear-motor 54 and connected by a second chain 56 to a second differential sprocket 62 mounted to the differential 28. Gear-motor 54 is geared to take the vehicle from about half speed up to a top speed. When gear-motor 54 takes over gear-motor 52 turns off and clutch bearing 64 allows sprocket 66 to free wheel without turning the shaft of gear-motor 52 thereby eliminating the extra drag of spinning the motor 52 at double its maximum speed. Electronic control may be used to control power to the two motors 52 and 54 and can be fully automatic which can greatly improve the efficiency and consequently the range of the vehicle. With the extra weight of the two gear-motors for this higher efficiency drive it can be seen that it is very important to keep the motors forward, low, and close to pivot point 64a to keep the un-sprung weight, the polar moment of inertia, and the center of gravity as low as possible.

Thus, the vehicle 50 starts from a stop under the power of the low vehicle speed motor 52. During low speed operation, the high vehicle speed motor 54 is driven back through the chain 56 and the sprockets 70 and 62, but only at low speed, and does not create substantial drag. At about half vehicle speed, electrical power is provided to the high vehicle speed motor 54 removed from the low vehicle speed motor 52. The clutch bearing 64 allows sprocket 66 to rotate without rotating the shaft of motor 52 thereby eliminating any extra drag from spinning the motor 52 at as much as twice its maximum RPM. The two motor drive may be electronically fully automatic which may greatly improve the efficiency and consequently the range of the vehicle.

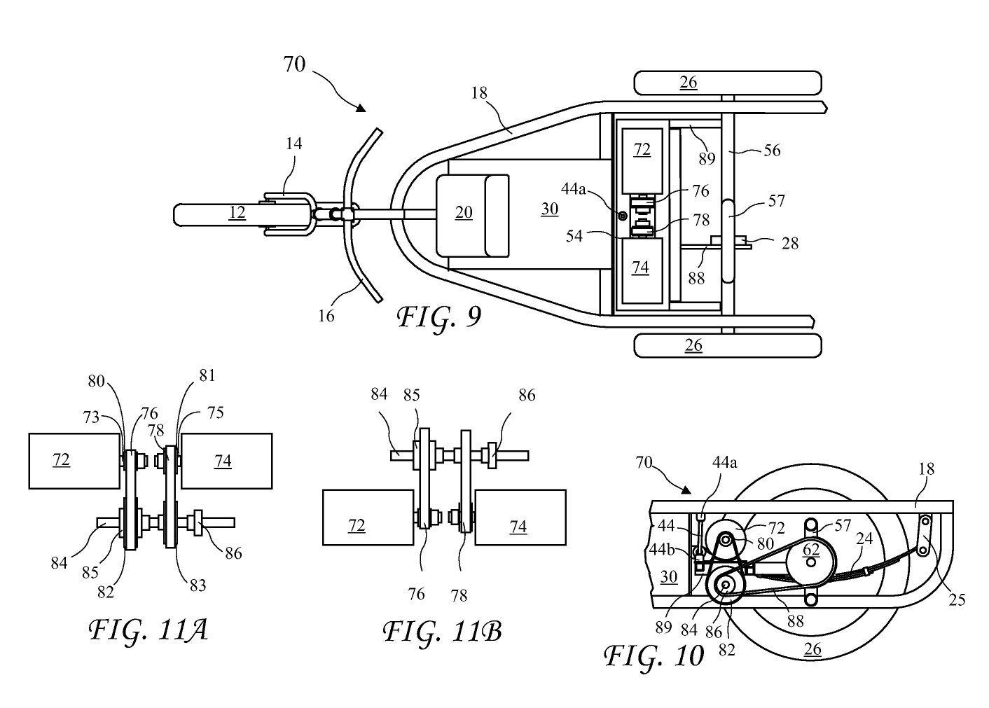

FIGS. 9 and 10 show another three wheel vehicle 70 according to the present invention with second a dual motor drive system employing a gearless low vehicle speed motor 72 and a gearless high vehicle speed motor 74, and a jackshaft 84 for speed reduction, all mounted in front of the live rear axle housing 56 and differential loop 57. FIG. 9 is a top view and FIG. 10 is a partial side view of the three wheel vehicle 70. The vehicle 70 is similar to the vehicle 50 of FIG. 5 except that the jackshaft 84 is coupled to both motors 72 and 74, and one chain 88 couples the jackshaft 84 to the differential sprocket 62. The motor 72 is adjustably mounted on the forward right side of the of motor mount 89 and the motor 74 is adjustably mounted on the forward, left side of motor mount 89. The jackshaft 84 is rotatably mounted to the motor mount 89 under motors 72 and 74 parallel to the motor shafts 73 and 75. A belt 76 couples a motor pulley 80 attached to the motor shaft 73 of the motor 72 with a jackshaft pulley 82 attached to the outer case of a clutch bearing 85 which is attached to jackshaft 84 (see FIG. 11A). A belt 78 couples a motor pulley 81 attached to the motor shaft 75 of the motor 74 with jackshaft pulley 83 attached to the jackshaft 84. The jackshaft 84 drives the differential 28 through the chain 88 connecting sprocket 86 directly attached to the jackshaft 84 and sprocket 62 attached to the differential 28.

The motor 72 is geared (using pulley ratios) to drive the vehicle 70 from stop to about half vehicle full speed, and when power is removed from the motor 72 and applied to the motor 74. The motor 74 is geared (also using pulley ratios) to drive the vehicle 70 from about half speed up to full speed. When power is switched to the motor 74, the motor 72 turns off and the clutch bearing 85 in pulley 82 allows jackshaft 84 to turn without turning the shaft 73 of the motor 72.

FIG. 11A shows details of the two gearless motors and the jackshaft with the motors mounted above the jackshaft and FIG. 11B shows details of the two gearless motors and the jackshaft with the motors mounted below the jackshaft. These two embodiments are very similar and selection of either embodiment may be based on a desire to lower the center of gravity (FIG. 11B) or other considerations.

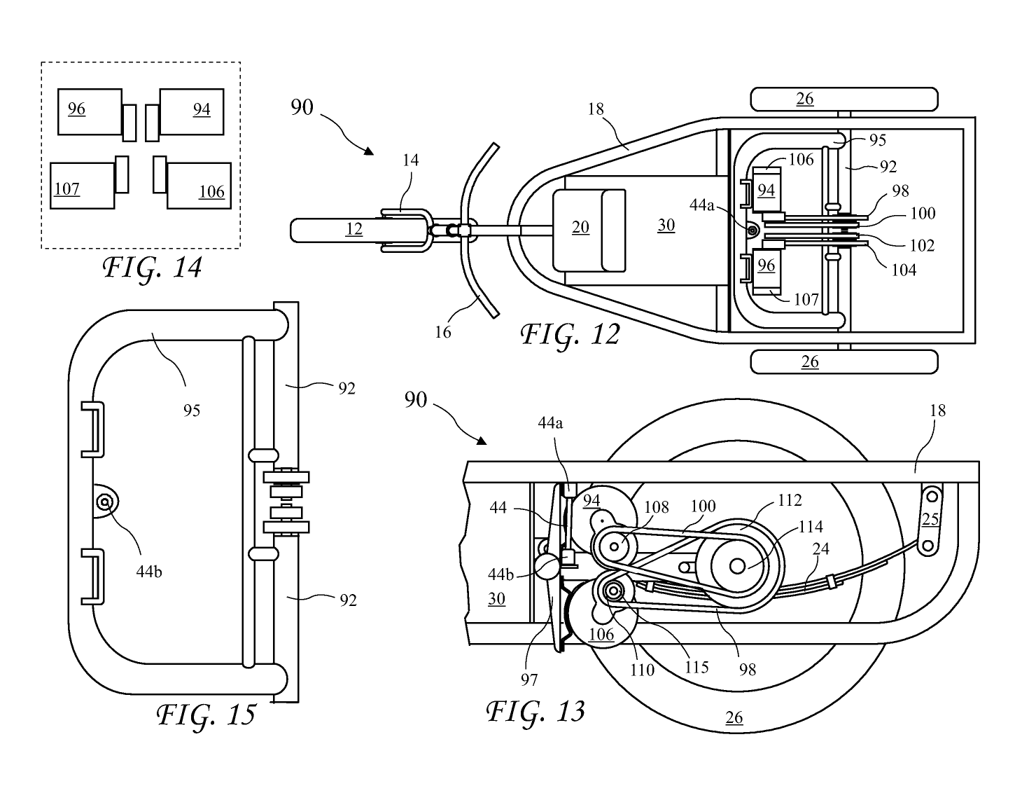

FIGS. 12 and 13 show another three wheel vehicle 90 according to the present invention with a four gear-motor drive system not requiring a differential, an arrangement of the four motors is shown in FIG. 14, and a motor mount 95 for the four gear-motor drive system is shown in FIG. 15. The vehicle 90 includes high speed gear-motors 94 and 96 and low speed gear-motors 106 and 107. The gear-motors 94 and 106 mounted as close as possible to lower pivot point 44b on the forward right side of motor mount 95, and drive the right axle and wheel of vehicle 90 in a similar way to how gear-motors 52 and 54 drive differential 28 in vehicle 50 (see FIG. 8). The gear-motors 96 and 107 are mounted as close as possible to pivot point 44b on the forward left side of the motor mount 95 and drive the left axle and wheel of vehicle 90 in a similar way to how gear-motors 94 and 106 drive the axle and wheel on the right side. The low gear motor sprockets are connected to the motor output shafts through clutch bearings 116 which allow the high speed gear-motors 94 and 96 to drive the vehicle 90 up to top speed without driving the low speed low speed gear-motors 106 and 107 to high RPM.

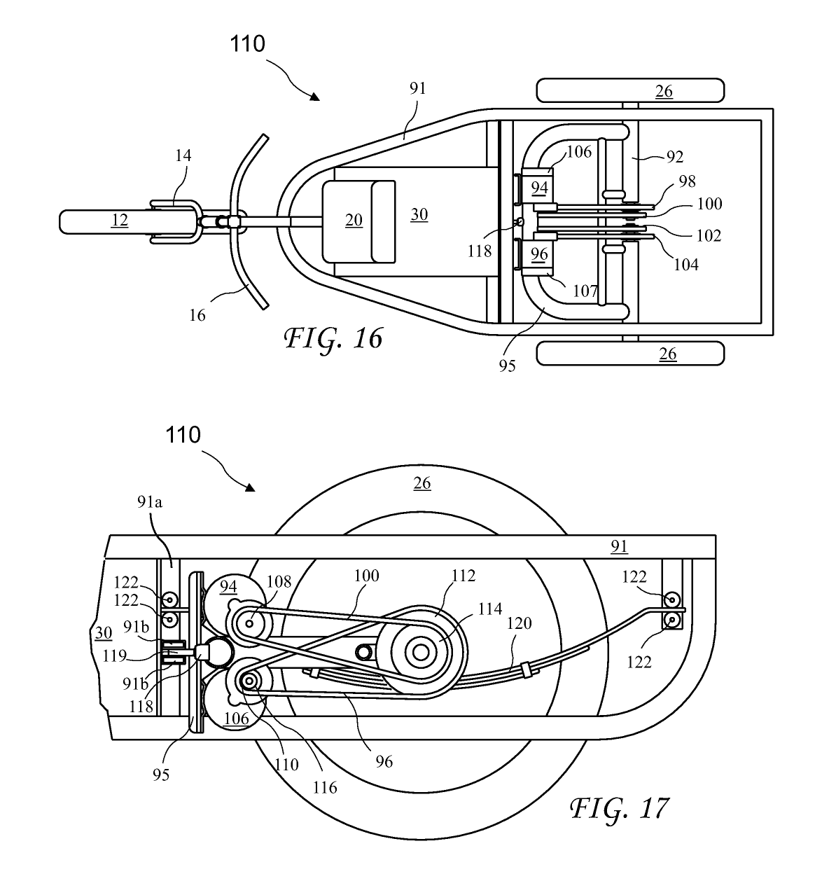

A top view of a second three wheel vehicle 110 including four motors mounted to the second motor mount 95 is shown in FIG. 16 and a partial side view of the second three wheel vehicle 110 is shown in FIG. 17. The vehicle 110 is similar to the vehicle 90 (see FIGS. 12-15) except that leaf springs 120 roll backward and forward in rollers 122 when the frame 91 moves vertically with respect to the rear axle 92. This allows the axle 92 and the motor mount 95, which are rigidly attached to each other, to rotate around the center of a swivel joint 118 attaching the motor mount 95 to the frame 91. The swivel 118 includes a fixed link 119 adjustably attached to frame lateral frame members 91b which extend between vertical frame members 91a. This also locates axle housing 92 in the forward and rear direction while keeping the unsprung weight to a minimum.

While a particular means of attaching the swivel 118 to the frame is described herein, vehicle 110 with a swivel attached to the frame by any means is intended to come within the scope of the present invention.

While the present invention is herein described using a chain and sprocket arrangement, the invention may alternatively be practiced by other mechanisms, including gears, belts and pulleys, and cog belts and pulleys.

As is well known by those skilled in the art, a clutch bearing allows free rotation of a sprocket on a shaft in one direction, and provides a fixed connection to transfer driving force from the shaft to the sprocket in an opposite direction. Further, the function performed by the clutch bearing may alternatively be performed by a number of other unidirectional rotating devices.

While the present invention has been illustrated by a description of the preferred embodiments and while these embodiments have been described in considerable detail in order to describe the best mode of practicing the invention, it is not the intention of the applicant to restrict or in any way limit the scope of the appended claims to such detail. For example the leaf springs and shackles could be replaced by many other types of rear suspension systems such as coil springs with locating rods.

I claim:

1. A two rear wheel driven three wheel vehicle comprising:
a frame;
forks attached to the frame for steering;
a front wheel held by the forks;
a live rear drive axle;
right and left rear wheels;
a rear suspension system connecting the live rear axle to the frame;
a motor mount connected to the axle housing at a rear of the motor mount and pivotally connected to the frame a motor mount front;
a drive unit mechanically coupled to the at least one of the rear wheels for driving the vehicle and residing closer to the motor mount front live rear drive axle than to the live rear drive axle.

2. The electric powered three wheel vehicle of claim 1, wherein the motor mount is connected to the frame through a vertical link.

3. The electric powered three wheel vehicle of claim 2, wherein the motor mount is connected to the vertical link by a lower swivel and the vertical link is connected to the frame by an upper swivel.

4. The electric powered three wheel vehicle of claim 1, wherein the motor mount is solidly connected to the live rear drive axle.

5. The electric powered three wheel vehicle of claim 1, wherein the motor mount is pivotally connected to the live rear drive axle.

6. The electric powered three wheel vehicle of claim 1, wherein the drive unit is an electric motor.

7. The electric powered three wheel vehicle of claim 1, wherein the drive unit comprises a low speed electric motor and a high speed electric motor, both motors mechanically coupled to the at least one of the rear wheels for driving the vehicle and residing closer to the motor mount front live rear drive axle than to the live rear drive axle.

8. The electric powered three wheel vehicle of claim 1, wherein the drive unit comprises a low speed electric motor and a high speed electric motor residing closer to the motor mount front live rear drive axle than to the live rear drive axle, both motors mechanically coupled to a jackshaft and the jackshaft coupled to the at least one of the rear wheels for driving the vehicle.

9. The electric powered three wheel vehicle of claim 8, wherein the low speed motor is connected to the differential through a clutch bearing so that when the high speed motor is operating at high RPM, the low speed motor is not turned by the high speed motor.

10. The electric powered three wheel vehicle of claim 1, wherein drive unit mechanically coupled to the both of the rear wheels for driving the vehicle.

11. The electric powered three wheel vehicle of claim 1, wherein:
the drive unit comprises two low speed motor and two high speed motors residing closer to the motor mount front than to the live rear drive axle;
each of the low speed motor are mechanically coupled to one of the rear wheels for driving the vehicle; and
each of the high speed motor are mechanically coupled to one of the rear wheels for driving the vehicle.

12. An electric powered three wheel vehicle comprising:
a frame;
forks attached to the frame for steering;
a front wheel held by the forks;
a battery pack carried by the frame;
a live rear drive axle having right and left axle shafts;
a leaf spring rear suspension system connecting the live rear axle to the frame;
a differential supported by the live rear axle and operatively connected to the right and left axle shafts;
an approximately vertical link;
an upper swivel joint connecting the link to the frame;
a motor mount connected to the live rear drive axle housing at a motor mount rear and to the link by a lower swivel joint at a motor mount front; and
an electric drive system residing closer to the motor mount front than to the live rear drive axle and operatively connected to the differential.

13. The electric powered three wheel vehicle of claim 12, wherein the drive unit comprises a low speed electric motor and a high speed electric motor, both motors mechanically coupled to the at least one of the rear wheels for driving the vehicle and residing closer to the motor mount front live rear drive axle than to the live rear drive axle.

14. The electric powered three wheel vehicle of claim 13, wherein the low speed motor is connected to the differential through a clutch bearing so that when the high speed motor is operating at high RPM, the low speed motor is not turned by the high speed motor.

15. The electric powered three wheel vehicle of claim 12, wherein the drive unit comprises a low speed electric motor and a high speed electric motor residing closer to the motor mount front live rear drive axle than to the live rear drive axle, both motors mechanically coupled to a jackshaft and the jackshaft coupled to the at least one of the rear wheels for driving the vehicle.
